(19) United States
(12) Patent Application Publication
(10) Pub. No.: US 2015/0106300 A1
(43) Pub. Date: Apr. 16, 2015

(54) COLLABORATIVELY ENHANCING BUSINESS INTELLIGENCE MODELS

(71) Applicants: Bruno Dumant, Verneuil sur Seine (FR); Alexis Naibo, Levallois-Perret (FR); Jean-Yves Cras, Paris (FR)

(72) Inventors: Bruno Dumant, Verneuil sur Seine (FR); Alexis Naibo, Levallois-Perret (FR); Jean-Yves Cras, Paris (FR)

(21) Appl. No.: 14/050,994

(22) Filed: Oct. 10, 2013

(51) Int. Cl. G06Q 10/06

(52) U.S. Cl. CPC G06Q 10/067
USPC 705/348

(57) ABSTRACT

The present disclosure relates to a computer-implemented method including identifying a predefined business intelligence model associated with a database, the predefined business intelligence model including one or more entities defining a structured organization of data and the predefined business intelligence model is adapted to access data from the database, identifying an enhanced business intelligence model based on the predefined business intelligence model, the enhanced business intelligence model incorporating by reference one or more entities of the predefined business intelligence model and providing the enhanced business intelligence model for accessing data from the database, accessing data from the database including using the one or more entities incorporated by reference in the enhanced business intelligence model, the predefined business intelligence model being unchanged.

### TECHNICAL FIELD

The present disclosure relates to methods and systems for database systems. In particular, the present disclosure relates to a method for collaboratively enhancing business intelligence models.

### BACKGROUND

The term Business Intelligence (BI) represents the tools and systems that play a key role in the strategic planning process of the corporation. These systems allow a company to gather, store, access and analyze corporate data to aid in decision-making Generally these systems can illustrate business intelligence in the areas of customer profiling, customer support, market research, market segmentation, product profitability, statistical analysis, and inventory and distribution analysis to name a few. Most companies collect a large amount of data from their business operations. To keep track of that information, a company might need to use a wide range of software programs, such as Excel, Access and different database applications for various departments throughout their organization. Using multiple software programs makes it difficult to retrieve information in a timely manner and to perform analysis of the data.

### SUMMARY

In a first general aspect of the present disclosure, a computer-implemented method includes identifying a predefined business intelligence model associated with a database, the predefined business intelligence model including one or more entities defining a structured organization of data and the predefined business intelligence model is adapted to access data from the database, identifying an enhanced business intelligence model based on the predefined business intelligence model, the enhanced business intelligence model incorporating by reference one or more entities of the predefined business intelligence model and providing the enhanced business intelligence model for accessing data from the database, accessing data from the database including using the one or more entities incorporated by reference in the enhanced business intelligence model, the predefined business intelligence model being unchanged.

In a second aspect according to the first aspect, the enhanced business intelligence model is set up by an analyst user having only read access to the predefined business intelligence model.

In a third aspect according to anyone of the first or second aspects, the method further includes identifying the enhanced business intelligence model and identifying a further enhanced business intelligence model based on the enhanced business intelligence model, the further enhanced business intelligence model incorporating by reference one or more entities of the enhanced business intelligence model.

In a fourth aspect according to the third aspect, the further enhanced business intelligence model is set up by a second analyst user having only read access to the predefined business intelligence model.

In a fifth aspect according to anyone of the preceding aspects, the predefined business intelligence model is set up by an IT technician having the right to create a business intelligence model.

In a sixth aspect according to anyone of the preceding aspects, the method further includes declaring the enhanced business intelligence model to be a read-only model that cannot be modified by one or more other analysts having only read access to the predefined business intelligence model, or declaring the enhanced business intelligence model to be a read/write model that can be modified by one or more other analysts having only read access to the predefined business intelligence model and write access to the enhanced business intelligence model.

In a seventh aspect according to anyone of the preceding aspects, the database is an in-memory database and wherein the database is associated with a production database system.

In an eighth aspect according to anyone of the preceding aspects, the enhanced business intelligence model is associated with an ad hoc database query definition.

In a ninth aspect according to anyone of the preceding aspects identifying an enhanced business intelligence model includes defining one or more new entities not present in the predefined business intelligence model.

In a tenth aspect according to anyone of the preceding aspects, identifying an enhanced business intelligence model includes adding new database tables to the predefined business intelligence model.

In an eleventh aspect according to anyone of the preceding aspects, the one or more entities of the predefined business intelligence model have an identifier that cannot be changed by an analyst setting up the enhanced business intelligence model.

In a twelfth aspect according to anyone of the preceding aspects, the method further includes defining an annotation for one or more entities of the predefined business intelligence model or one or more of their attributes for organizing the one or more entities in the enhanced business intelligence model.

In a thirteenth aspect according to anyone of the preceding aspects, the method further includes notifying an IT technician having read and write access to the complete database that an enhanced business intelligence model has been set up and adding the enhanced business intelligence model to the predefined business intelligence model to create a modified business intelligence model.

In a fourteenth aspect according to the thirteenth aspect, the method further includes notifying other users of the database using the predefined business intelligence model about the modified business intelligence model.

In a fifteenth aspect according to anyone of the preceding aspects, the enhanced business intelligence model incorporates one or more entities of the predefined business intelligence model by referencing without rewriting the one or more entities.

In a sixteenth aspect according to anyone of the preceding aspects, the method further includes changing the predefined business intelligence model to include one or more enhancements of the enhanced business intelligence model to create a modified business intelligence model and automatically mapping the references to the one or more entities of the predefined business intelligence model to one or more entities of the modified business intelligence model.

In a seventeenth aspect according to the sixteenth aspect, a user of the predefined business intelligence model is not notified about the creation of the modified business intelligence model.

In an eighteenth aspect according to the sixteenth or seventeenth aspects, the method further includes copying the predefined business intelligence model to create a backup version of the predefined business intelligence model and notifying a user about the creation of the modified business intelligence model.

In a nineteenth aspect according to anyone of the preceding aspects, the method further includes copying the predefined business intelligence model to create a copied predefined business intelligence model, changing the copied predefined business intelligence model to include one or more enhancements of the enhanced business intelligence model to create a modified business intelligence model, marking the predefined business intelligence model as deprecated and instructing a user to change the references from the deprecated predefined business intelligence model to the modified business intelligence model.

In a second general aspect of the present disclosure, a computer readable medium storing instructions thereon which when executed by a processor cause the processor to execute anyone of the methods of aspects 1 to 19.

In a third general aspect of the present disclosure, a system includes one or more processor and a computer-readable medium storing instructions executable by the one or more processors to perform operations according to anyone of the methods of aspects 1 to 19.

### BRIEF DESCRIPTION OF THE DRAWINGS

FIG. 1 illustrates example business intelligence models of a business intelligence database system.

FIG. 2 illustrates the operation of integrating an enhanced business intelligence model into a predefined business intelligence model.

FIG. 3A illustrates an example method to create a modified business intelligence model based on a predefined business intelligence model.

FIG. 3B illustrates another example method to create a modified business intelligence model based on a predefined business intelligence model.

FIG. 3C illustrates a third example method to create a modified business intelligence model based on a predefined business intelligence model.

FIG. 4 illustrates an example business intelligence database system.

FIG. 5 illustrates examples of the operations described in connection of FIG. 1, FIG. 2 and FIG. 3A to FIG. 3C.

FIG. 6 illustrates an example method of enhancing business intelligence models.

Reference numbers and designations in the various drawings indicate exemplary aspects, implementations or embodiments of particular features of the present disclosure.

### DETAILED DESCRIPTION

The present disclosure relates to methods and systems for database systems. In particular, the present disclosure relates to a method for collaboratively enhancing business intelligence models.

In some business intelligence database systems, a dedicated group of users (“IT technicians”) has extensive rights to create, modify, and change business intelligence models employed in the business intelligence database systems. The remaining users have only limited rights, for example, only rights to execute one or more predefined queries defined in the business intelligence model. However, all users might have the wish to tailor the business intelligence model according to their respective needs. This can include, e.g., when a user intends to define his or her own indicators or metrics (e.g., a team leader of wants to define a query to determine a probability that members of his or her team reach their yearly goals). Due to his limited rights, the user might be unable to modify the business intelligence model himself and would have to contact an IT technician to implement the enhancements. This can be a lengthy and cumbersome process. Thus, the user can be tempted to use copies of the IT-governed database data of the business intelligence model to circumvent involving an IT technician. This may lead to the proliferation of so called “shadow” business intelligence systems, i.e., personal copies of the IT-governed data with user-defined business intelligence. The accuracy of the data in these shadow business intelligence systems can be low as the user's data manipulation is often error-prone and the data is not subject to centralized control. In addition, the hybrid business intelligence solutions including IT-governed business intelligence and shadow business intelligence systems can lack real-time capabilities due to the necessity to copy data between shadow business intelligence data structures and IT-governed data structures.

On the other hand, it can be impractical as well to grant all users extensive rights create, modify and change the business intelligence models of business intelligence database system as these user modifications cannot be controlled and tested by IT technicians. This can also impair the efficient operation of the business intelligence database systems.

The subject-matter described in this disclosure can be implemented in particular embodiments so as to address the deficiencies discussed above and to realize one or more of the following advantages.

First, a business intelligence database system can be provided that empowers users with restricted rights to enhance predefined business intelligence models. In this manner, each user can efficiently tailor the business intelligence model according to his or her needs. For example, each user can define his or her own indicators and metrics. In addition, users can integrate external data into the database.

Second, the proliferation of shadow business intelligence can be avoided or reduced. In particular, copying of data or database structures can be avoided or reduced. In this manner, data integrity can be improved and the business intelligence database system can serve data faster as data can be served from central repositories (and not from shadow business intelligence systems such as personal spreadsheets).

Third, the users can easily share their business intelligence model enhancements with other users and in particular can let IT technicians integrate them into the underlying business intelligence model to secure that enhancement of business intelligence models are properly tested.

Fourth, user defined business intelligence model enhancements can be integrated seamlessly into a running business intelligence database system. Delays and other inconveniences due to modifications can be avoided.

As used in the present disclosure, a “business intelligence model” organizes and structures raw business data of a database. A business intelligence model can provide different functions to allow end users to find, compile, analyze and present raw business data. For example, a database can include personal information regarding the employees of a company and sales data of the company. In an example business intelligence model, the sales data can be linked to particular employees who sold respective products. Then, a manager can pull together performance data for particular employee in an efficient manner by using the business intelligence model. A business intelligence model includes one or more entities. As used herein, the term “entity” of a business intelligence model designates a business concept that is supposedly familiar to end users.

For instance, an entity of a business intelligence model can be a dimension which represents sets of one or more real-world entities (e.g., customers, dates, products, employees). Dimensions can be used to structure and analyze the raw data of the database. For instance, a dimension can be filtered to generate a list of members of the set of one or more real-world entities included in the particular dimension having a predetermined attribute. In addition or alternatively, an entity of a business intelligence model can be a dimension detail or attribute. A dimension detail or attribute is additional information attached to members (values) of a dimension (e.g., a dimension “customer” can include the customers of a company, and a dimension detail or attribute for each member can be a customer's address) In addition or alternatively, an entity of a business intelligence model can be a measure. A measure or metric is a function of one or more dimensions or one or more dimension values, or both, and yields an output value. For instance, a measure can include a numeric value that can be computed for a combination of dimension values (e.g., a total value of sales of a set of products to a set of customers). In addition or alternatively, multiple entities of a business intelligence model can be grouped in a container-entity, a folder-entity or a namespace-entity, which are used to organize the entities of the business intelligence model.

A business intelligence database system is the computerized system on which a business intelligence application including the business intelligence model executes. In the following, the systems will be described on a functional level. These systems can be embodied in different hardware and software environments as described in detail below. Even if the systems and methods described below can have particular advantages in specific hardware and software environments (e.g., in a client-server system or a cloud computing environment), the systems and methods described below are not limited to a particular hardware and software environments. Rather, the systems and methods described below can be deployed in any hardware and software environment capable of providing the described functionalities.

An “enhanced business intelligence model” includes expansion of an existing business intelligence model. For instance, an enhanced business intelligence model can include additional external data. In addition or alternatively, an enhanced business intelligence model can include new or modified entities. For example, an enhanced business intelligence model can include new metrics, dimensions or attributes.

As used in the present disclosure, an “IT technician” is a user of a business intelligence database system having rights to create new business intelligence models. In contrast to that, an “analyst” is a user of a business intelligence database system having no rights to create new business intelligence models but having rights to read a predefined business intelligence model (e.g., a predefined business intelligence model created by an IT technician). In addition, an analyst can, in some instances and situations, have the rights to modify or delete enhanced business intelligence models created by other analysts. The analyst can have one or more additional rights depending on his role in a company and a setup of a particular business intelligence database system. In some instances, an analyst may also be an IT technician (based on their read-write rights), but may choose to create or modify an enhanced business intelligence model without affecting the underlying business intelligence model.

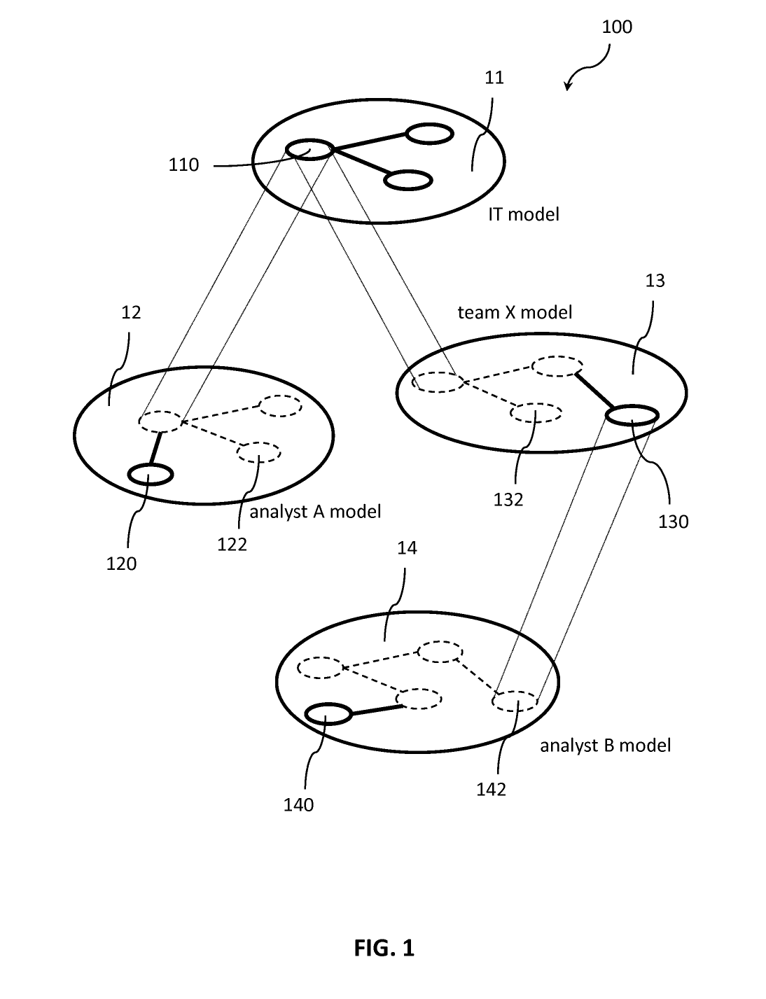

FIG. 1 illustrates example business intelligence models of a business intelligence database system. An example method for a collaboratively enhancing a business intelligence model will be described in connection with FIG. 1. The example process of FIG. 1 includes an IT technician and three different analysts. However, it is not essential that a particular operation is carried out by a particular user. Different operations can also be carried out by the same user. In addition, a group of users can collectively carry out a particular operation.

In a first operation, a predefined business intelligence model 11 including one more entities is created by an IT technician. The IT technician provides the predefined business intelligence model 11 for access by other users of the business intelligence database system, and allows those users to create modified or enhanced versions of the model 11. In a second operation, analyst A defines an enhanced business intelligence model 12 based on the predefined business intelligence model (e.g., analyst A defines a particular metric not yet available in the predefined business intelligence model 11). However, instead of re-writing or copying the entities 110 of the predefined business intelligence model 11 (e.g., a set of input attributes for the new metric) created by the IT technician, analyst A incorporates the entities 110 of the predefined business intelligence model by reference in the identified enhanced business intelligence model 12. Analyst A can have no rights to otherwise modify, delete or create the entities 110 of the predefined business intelligence model 11. However, he can have read access to the entities 110 of the predefined business intelligence model 11. This allows analyst A to incorporate the entities 110 of the predefined business intelligence model 11 in the enhanced business intelligence model 12. As a result, the enhanced business intelligence model 12 includes an enhancement 120 and one or more referenced entities 122 which are derived from the entities 110 of the predefined model 11. The changes from the enhanced business intelligence model 12 can be incorporated with the underlying predefined business intelligence model 11 at runtime. This means that when using the one or more entities incorporated by reference in the enhanced business intelligence model the predefined business intelligence model is unchanged

Analyst A can decide to declare the enhancement as “read only.” In this manner, other analysts cannot edit the enhanced business intelligence model 12. Alternatively, analyst A can declare the enhancement as “read/write.” In this manner, other analysts can edit the enhanced business intelligence model 12. In a further operation, the analyst A can use or allow other user to use the enhanced business intelligence model 12 for accessing data from the database. Alternatively or in addition, analyst A can declare the enhancement as “execute.” In this manner, other analysts can see data values associated to an entity or model. Alternatively or in addition, analyst A can declare the enhancement as “view definition.” In this manner, other analysts can see how entities of the enhancement are defined in reference to others.

In a further operation, another analyst (or team of analysts) identifies a second enhanced business intelligence model 13 (denoted as “team X model” in FIG. 1). For example, the other analyst can add external data to the predefined business intelligence model 11. Again, the second enhanced business intelligence model 13 incorporates by reference one or more entities 110 of the predefined business intelligence model 11 to create one or more referenced entities 132 in the second enhanced business intelligence model 13. In addition, the second enhanced business intelligence model includes an enhancement 130 identified by the other analyst. In a further operation, an analyst B (e.g., a member of team X) identifies a third enhanced business intelligence model 14 based on the second enhanced business intelligence model 13. Analyst B incorporates each of the entities 132, including object 130, in the third enhanced business intelligence model 14 by reference to create one or more referenced entities 142 in the third enhanced business intelligence model 14. In addition, analyst B identifies a third enhancement 140 (e.g., a particular query) for the third enhanced business intelligence model 14.

As described above, three different analysts can collaboratively enhance a predefined business intelligence model 11 without rewriting existing entities or copying data. In this manner, the creation of shadow business intelligence can be avoided. As illustrated in the example of FIG. 1, each enhanced business intelligence model 12, 13, 14 references the required entities of the predefined business intelligence model 11 (and any related enhanced business intelligence models), which are only editable by the IT technician. This can improve data accuracy and speed of the business intelligence database system.

Even though the different analysts have added new entities to a previously identified business intelligence model, analysts can also modify enhanced business intelligence models identified earlier. An analyst can share an enhanced business intelligence model in one of different manners. In a first embodiment, an analyst can share an enhanced business intelligence model as “read only.” This means that other analysts can, as in the example of FIG. 1 incorporate one or more entities of the enhanced business intelligence object by reference but cannot edit the enhancement added by the analyst who identified the enhanced business intelligence model. In other embodiments, an analyst can share an enhanced business intelligence model as “read/write.” This means that other analysts can not only read the enhanced business intelligence model's entities to create a further enhanced business intelligence model, but they can also modify the entities of the enhanced business intelligence model. Although read only and read/write permissions have been described in detail above, an analyst (and also an IT technician) can also share a business intelligence model with other specified permissions. For example, an analyst can share an enhanced business intelligence model and specify that other analysts can delete an enhancement or update an enhanced business intelligence model, or other specific portions of a particular enhanced business intelligence model. In other embodiments, a write access might allow other analysts to identify only specific modifications. For instance, an analyst can specify that other analysts are only allowed to read, delete or modify a limited part of the enhancement (e.g., to modify a particular formula or a filter in the enhanced business intelligence model, and not to add new entities).

The system and method for collaboratively enhancing a business intelligence model of FIG. 1 will subsequently further explained by means of a concrete example. In this example, the business intelligence database system is a customer relationship management database system. The customer relationship management database system includes a predefined business intelligence model that captures a customer relationship management database schema. Analyst P decides to develop an enhanced business intelligence model based on the predefined business intelligence model. Analyst P launches a client application of the customer relationship management database system. In a next operation, he selects entities of the predefined business intelligence model to be used in his enhanced business intelligence model. For examples, analyst P selects the entities named “customer” “sales person,” “half year,” “month,” and “turnover” and combines them in a new container entity. The client application of the customer relationship management database system creates the new container entity of the enhanced business intelligence model by referencing current entities of the predefined business intelligence model. Analyst P has only read permission to the predefined business intelligence model of the customer relationship management database system. Therefore, he can use the entities of the predefined business intelligence model in his enhanced business intelligence model but cannot edit the entities. For example, analyst P can hide attributes of the entities of the enhanced business intelligence model to other users (e.g., “consumers” of his enhanced business intelligence model). In addition, as will be described in more detail below, analyst P can annotate the referenced entities of the predefined business intelligence model. For example, the referenced entities named “sales person” include as attributes the “company ID,” “name,” “last name,” “address,” and “phone number” of a particular sales person. Analyst P decides to hide the attributes “company ID,” “address,” and “phone number.” In addition analyst P adds a new attribute entitled “full name” and defines the attribute full name as a combination of the attributes “name” and “last name.” These operations neither edit the underlying entities of the predefined business intelligence model nor does analyst P have to copy the entities of the predefined business intelligence model. For example, even though some attributes are hidden in the enhanced business intelligence model identified by analyst P, these attributes are still available in the predefined business intelligence model for other analysts. In addition, the data of the predefined business intelligence model is not edited by analyst P. On the other hand, all data and all entities of the predefined business intelligence model used in the enhanced business intelligence model are incorporated by reference. No fault-prone copying operations are required.

In a next operation, analyst P discovers that a “turnover per half year per salesperson” metric is not available in the predefined business intelligence model. He decides to add a metric “half year turnover” to the enhanced business intelligence model as the cumulated turnover of a salesperson in a particular half year. Analyst P then saves the enhanced business intelligence model to a repository (e.g., an in-memory database). In a further operation, analyst P published the enhanced business intelligence model with read and write rights to the members of a “sales organization” team. This means that members of the sales organization team can modify or extend the enhanced business intelligence model identified by analyst P. For instance, another analyst R of the sales organization team can access the enhanced business intelligence model and decide that she would like to modify the enhanced business intelligence model as the business year of the company ends on September 30. As analyst P has published his enhanced business intelligence model with read and write permissions for members of the sales organization team, analyst R can modify the formula of the half year turnover metric to calculate the cumulated turnover (e.g., shift the starting point to October 1) and rename the metric as “half business year turnover.” After having identified this second enhanced business intelligence models, she again saves and publishes it. In this manner, multiple users of a business intelligence database system can collaboratively enhance a business intelligence model.

It has been described above that an analyst can rename entities of the predefined business intelligence model. In the systems and methods described herein, an entity of a business intelligence model can have an entity identity (e.g., an alphanumerical key) and an annotation (e.g., a second alphanumerical key). An analyst can change an annotation of an entity during development or definition of an enhanced business intelligence model. The entity identities, on the other hand, may not be directly exposed to the analysts and thus cannot be modified by the analysts. In this manner, entities can be organized and reorganized independently of their identity. This simplifies keeping track of the entities of the business intelligence models and avoids or reduces the number of renaming operations. The same applies for new entities of the enhanced business intelligence entities. These entities can have an identifier not directly exposed and an annotation for organizing and reorganizing the new entities as well.

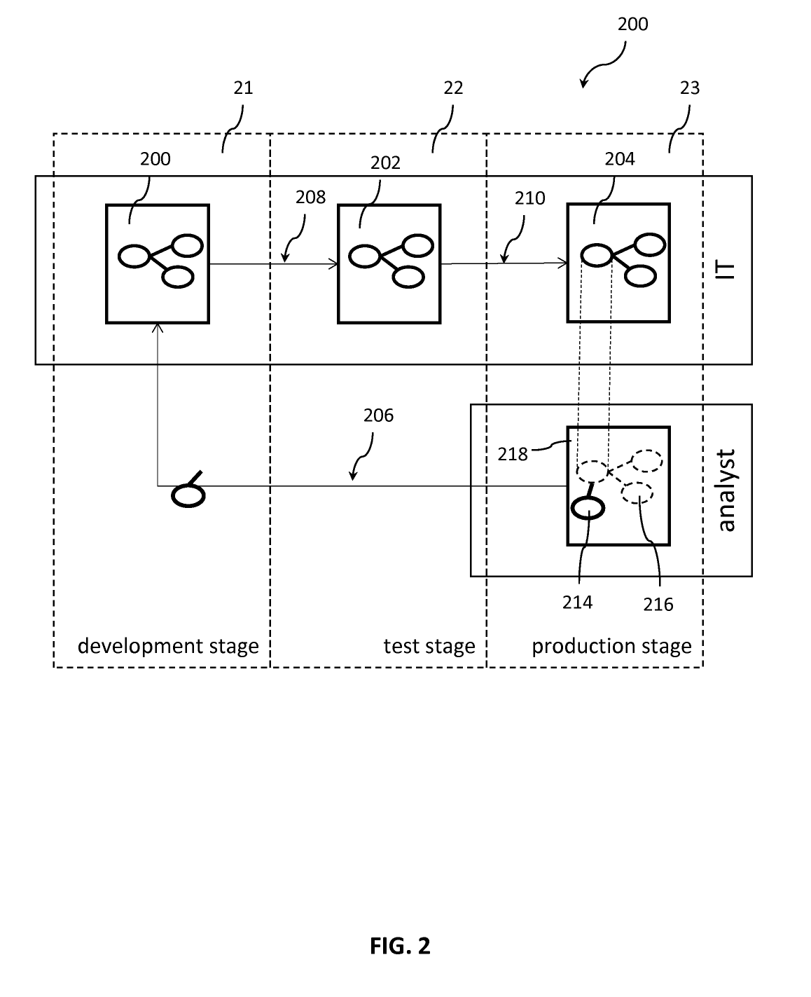

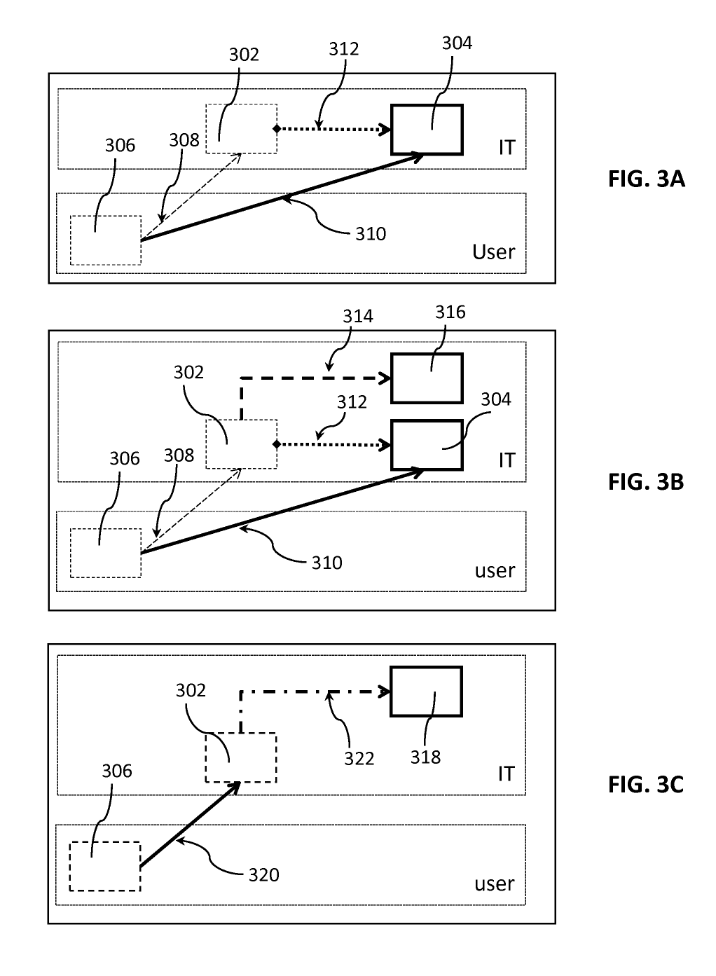

It has been described in connection with FIG. 1 how analysts can identify enhanced business intelligence models and share this enhanced business intelligence models with other analysts. In connection with FIGS. 2 and 3, it will be described how these enhanced business intelligence models can be integrated into the predefined business intelligence model to make their functionality available to users of the business intelligence database system and secure that these enhanced business intelligence models are properly tested before being released.

FIG. 2 illustrates the operation of integrating an enhanced business intelligence model into a predefined business intelligence model. FIG. 2 shows three stages of a business intelligence model development process. In a first development stage 21, a predefined business intelligence model 200 is created. In the example of FIG. 2, this process is carried out by an IT technician. After the predefined business intelligence mode 200 has been created, it is transported 208 to a subsequent test stage 22 where it is tested. This can include modifying the predefined business intelligence model 202. These operations can also be performed by an IT technician. The development stage 21 and the test stage 22 can be combined into one stage, can overlap, or can alternate. Alternatively or in addition, there can be additional stages. For instance, analysts can have access to a development system for their enhancements, which can be different from a development system accessed by end users. In other examples, analysts and end users can share a single development system. In a next operation, the business intelligence model is transported (210) to a production stage 23. In this production stage 23, it is available to all users of the business intelligence database system who can use the business intelligence model 204 in a business intelligence database application. In addition, analysts can define or develop one or more enhanced business intelligence models 218 by referring to entities of the predefined business intelligence model 204 and adding enhancements 214. Details of these operations have been described above in connection with FIG. 1.

After an analyst has identified an enhanced business intelligence model, the analyst can notify (206) the IT technician that an enhanced business intelligence model has been set up. The IT technician can bring the predefined business intelligence model 204 and the identified enhancement 214 back to the development stage. For example, an enhancement 214 can be copied back to a development system of the predefined business intelligence model 204. In a subsequent operation, the IT technician can integrate the enhancement in the predefined business intelligence model to create a modified business intelligence model. Then, the IT technician can test the modified business intelligence model and eventually transport it to a production stage if he thinks that the enhancement is interesting for other users and operates properly. In this manner, enhancements for predefined business intelligence models identified by a particular analyst can be propagated in the underlying predefined business intelligence model and thus can be available for all users of the business intelligence database system. Statistics and feedback on the usage of particular enhancements may be provided to the IT department and the IT technicians for incorporation into the underlying business intelligence models. Details of this update procedure will be described subsequently in connection with FIG. 3A, FIG. 3B and FIG. 3C.

FIG. 3A illustrates a first method to handle changes in business intelligence models by creating a modified business intelligence model based on a predefined business intelligence model. In the example of FIG. 3A a user (e.g., an analyst) uses a predefined business intelligence model 302. For example, the user can have referenced 308 one or more entities of the predefined business intelligence model 302 while defining an enhanced business intelligence model 306. Meanwhile, the IT technician can create (312) a modified business intelligence model 304 including a minor modification of the predefined business intelligence model 302 with no semantic impact on the business intelligence model. In this situation, the IT technician can change the predefined business intelligence model 302 into the modified business intelligence model 304 and the business intelligence database application can automatically map the references 308 to one or more entities of the predefined business intelligence model 302 to the respective on or more entities of the modified business intelligence model 304. In this manner, the user experience is not compromised by delays or even necessary restarts of the business intelligence database application after the modified business intelligence model 304 has been created.

FIG. 3B illustrates a second method to handle changes in business intelligence models by creating a modified business intelligence model based on a predefined business intelligence model. In the example of FIG. 3B a user (e.g., an analyst) uses a predefined business intelligence model 302. Again, the user can have referenced 308 one or more entities of the predefined business intelligence model 302 while defining an enhanced business intelligence model 306. Meanwhile, the IT technician can create 312 a modified business intelligence model 304 including a modification of the predefined business intelligence model 302 with minor semantic impact on the business intelligence model. In this situation, the IT technician can change the predefined business intelligence model 302 into the modified business intelligence model 304 and the business intelligence database application can automatically map the references 308 to one or more entities of the predefined business intelligence model 302 to the respective one or more entities of the modified business intelligence model 304. This part of the creation process of the modified business intelligence model of FIG. 3B is identical to the process of FIG. 3A. However, in the process of FIG. 3B, the IT technician additionally creates (314) a copy 316 of the predefined business intelligence model 302. Optionally, the user can be notified that a copy 316 of the predefined business intelligence model 302 has been created. For example, an identifier of the copy 316 of the predefined business intelligence model 302 can be transmitted to the user. The user can then change the references 310 from referring to one or more entities of the modified business intelligence model 304 to referring to one or more entities of the copy 316 of the predefined business intelligence model 302. This can be advantageous if the enhanced business intelligence model 306 the user is in the process of defining or developing is impacted by the semantic changes of the modified business intelligence model 304.

FIG. 3C illustrates a third method to handle changes in business intelligence models by creating a modified business intelligence model based on a predefined business intelligence model. In the example of FIG. 3C a user (e.g., an analyst) uses a predefined business intelligence model 302. For example, the user can have referenced 320 one or more entities of the predefined business intelligence model 302 while defining an enhanced business intelligence model 306. Meanwhile, the IT technician can create (312) a modified business intelligence model 304 including a major modification of the predefined business intelligence model 302 with no major semantic impact on the business intelligence model. For example, this major modification can include deleting one or more entities of the predefined business intelligence model 302. In this situation, other than in the methods described in connection with FIG. 3A and FIG. 3B, the references 308 to the predefined business intelligence model 302 are not automatically mapped to a modified business intelligence model. Rather, the IT technician first copies (322) the predefined business intelligence model and subsequently changes the copy of the predefined business intelligence model 302 to create the modified business intelligence model 318. Optionally, the user can be notified of the creation of the modified business intelligence model 318 and, further optionally, the users can be instructed to change the references 308 to one more entities of the predefined business intelligence model 302 to the modified business intelligence model 318 (e.g., a predefined deadline can be set for the user). In this manner, the user can seamlessly work with the current enhanced business intelligence model 306 and is not impaired by the problems an automatic mapping of the references 308 might cause due to the major modifications in the modified business intelligence model compared to the predefined business intelligence model. Again, an identifier of the modified business intelligence model 318 can be transmitted to the user to allow the user to change the references 308 to the modified business intelligence model 318.

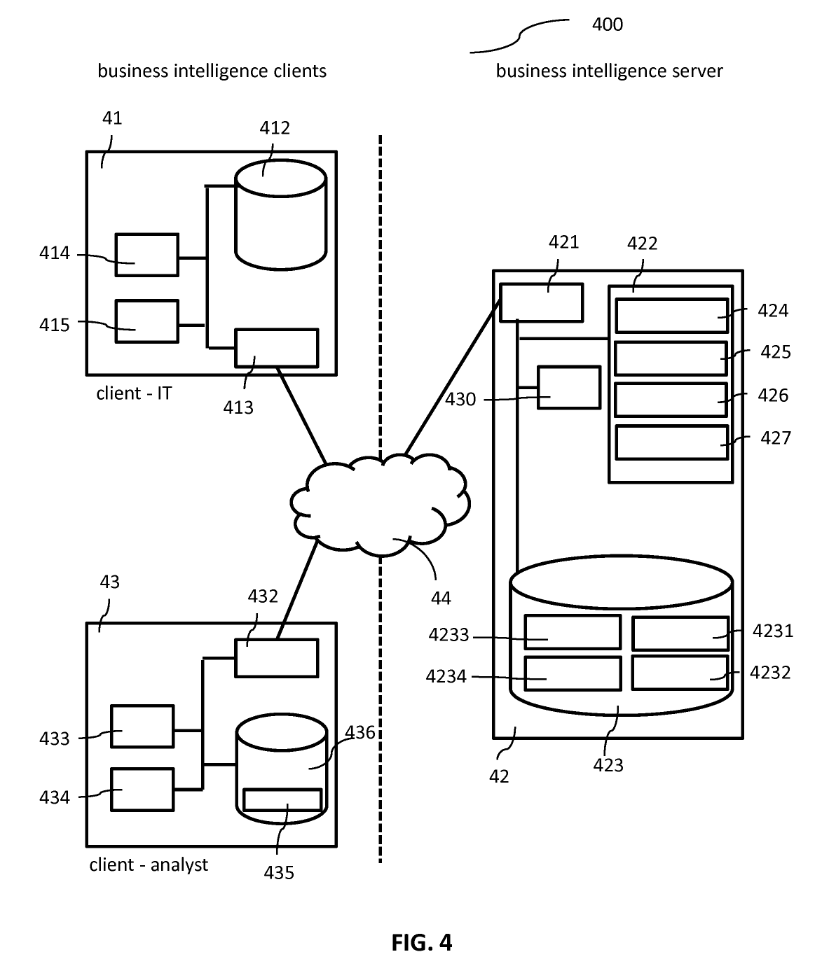

In connection with FIG. 1, FIG. 2, and FIG. 3A, FIG. 3B and FIG. 3C different aspects of methods to generate and propagate enhanced business intelligence models have been discussed. In FIG. 4 an example environment for carrying out the methods described above. In the example of FIG. 4 the business intelligence database system is set up in a client-server environment where multiple business intelligence client 41, 43 are connected to a business intelligence server 42 over a network 42. In connection with FIG. 4, the different units of the business intelligence application system are described as functional units. These functional units can be embodied in any of the hardware and software environments described below. For example, the business intelligence clients 41, 43 can run on desktop or mobile computers and the business intelligence server 42 can be a remote server device. Alternatively or in addition, part or all of the functionalities of the business intelligence server 42 can be run in a cloud-computing and/or on-demand environment. The network 44 can be any network suitable to support data communication between the business intelligence server 42 and the multiple business intelligence clients 41, 43 (e.g., the networks described below).

Each of the business intelligence clients 41, 43 and the business intelligence server 42 includes an interface 413, 421, 432 to interface to the network and 43 and the remaining business intelligence clients 41, 43 and the business intelligence server 42. Moreover, the business intelligence clients 41, 43 and the business intelligence server 42 include a memory 412, 423, 432 for storing data associated with the respective business intelligence database system unit (i.e., client or server). In one example, the memories 412, 432, 423 are embodied in volatile memory. For example, the business intelligence server 42 can be associated with an in-memory database to provide for a quick service of database data stored in the memory 423 of the business intelligence server 42. The business intelligence server 42 can, alternatively or in addition, be associated with persistent memory. In addition, each of the business intelligence clients 41, 43 and the business intelligence server 42 has a processor 415, 430, 434 to process operations of the respective unit of the business intelligence database system. Moreover, each of the business intelligence clients 41, 43 can optionally have a graphical user interface 414, 433, 429 (or any other suitable I/O device) to allow users of the business intelligence database system (e.g., analysts or IT technicians) to operate the business intelligence database system.

At the business intelligence server, a predefined business intelligence model 4233, a modified business intelligence model 4232, one or more enhanced business intelligence models 4234 and a database 4231 can be stored in-memory (possibly at different times). One or more of these entities can also be stored elsewhere, for example in-memory at the business intelligence clients 41, 43. For instance, if an analyst operating the analyst business intelligence client 43 is in the process of identifying an enhanced business intelligence model, all or part of the enhanced business intelligence model can be stored in memory 436 associated with the analyst business intelligence client 43. In other embodiments, one or more parts or the complete database 423 are stored in a persistent memory, as well as other suitable alternatives to in-memory databases.

In the example of FIG. 4, the business intelligence server 42 includes a business intelligence enhancement collaboration engine 422. This collaboration engine 422 provides the functionalities described above in connection with FIG. 1, FIG. 2 and FIG. 3A, FIG. 3B and FIG. 3C. Even though the collaboration engine 422 is depicted in FIG. 4 as part of the business intelligence server 42, the collaboration engine 422 or parts of it can also be part of one or more business intelligence clients 42, 43. In the embodiment of FIG. 4, the collaboration engine 422 includes different modules 424, 425, 426, 427, 428 for implementing the methods described above. The business intelligence database system can also include only selected ones of the modules 424, 425, 426, 427, 428. A business intelligence modeling module 424 provides some or all of the functions for identifying an enhanced business intelligence model described in connection with FIG. 1. For instance, the business intelligence modeling module 424 can output to a client information regarding the entities of the predefined business intelligence model 4233, information regarding the one or more enhanced business intelligence models 4234 and provide tools for identifying an enhanced business intelligence model. A business intelligence change monitor 425 and a business intelligence change notifier 426 can perform some of the operation described in connection with FIG. 2 and FIG. 3A, FIG. 3B and FIG. 3C. For instance, the business intelligence change monitor 425 can keep track of the modifications of the predefined business intelligence model 4233 implemented by an IT technician via the IT business intelligence client 41. These changes can be reported to an analyst business intelligence client 43 if a minor or major modification of the semantic structure of the predefined business intelligence model 4233 is implemented, as described in connection with FIG. 3B or 3C. The analyst operating the analyst business intelligence client 43 can then use the business intelligence modeling module 424 to change the references to entities of the modified business intelligence model 4232. Moreover, an enhancement integrator 427 can carry out some or all of the operations described in connection with FIG. 2 and FIG. 3A, FIG. 3B and FIG. 3C relating to the integration of the enhancements of the one or more enhanced business intelligence models 4234 into the predefined business intelligence model 4233 to create a modified business intelligence model 4232. For instance, the enhancement integrator 427 can copy a predefined business intelligence model to provide a backup. In addition, the enhancement integrator 427 can automatically map references of enhanced business intelligence models from a predefined business intelligence model to a modified business intelligence model. Further, the enhancement integrator 427 can perform the runtime integration of the enhanced business intelligence models into the predefined business intelligence model for seamless enhancement and usage of the enhanced model.

In the example of FIG. 4, the business intelligence database system includes a first business intelligence client 41 that is operated by an IT technician. A second business intelligence client 43 is operated by an analyst. As described above, the two business intelligence clients 41, 43 have different permissions to access the business intelligencer models. The IT business intelligence client 41 can provide an IT technician with access to tools to create and modify predefined business intelligence model or to react to a notification of an analyst client to propagate a particular enhanced business intelligence model by integrating a particular enhancement into a predefined business intelligence model (see, e.g., the operations described in connection with FIG. 2). The analyst business intelligence client 43 can provide an analyst with access to tools for identifying an enhanced business intelligence model, as described in connection with FIG. 1. Optionally, the analyst business intelligence client 43 can provide an analyst with access to tools for receiving notifications from the business intelligence change notifier 426 of the business intelligence server 42 regarding changes in a predefined business intelligence model. Still further optionally, the analyst business intelligence client 43 can provide an analyst with access to tools for changing references of a current enhanced business intelligence model from entities of a predefined business intelligence model 4233 to entities of a modified business intelligence model 4232. The analyst business intelligence client 43 can provide the possibility to load external data 435 into the memory 436 of the analyst business intelligence client 43. As described above in connection with FIG. 1, this external data 435 can be added to an enhanced business intelligence model 4233 during the identification process of the enhanced business intelligence model.

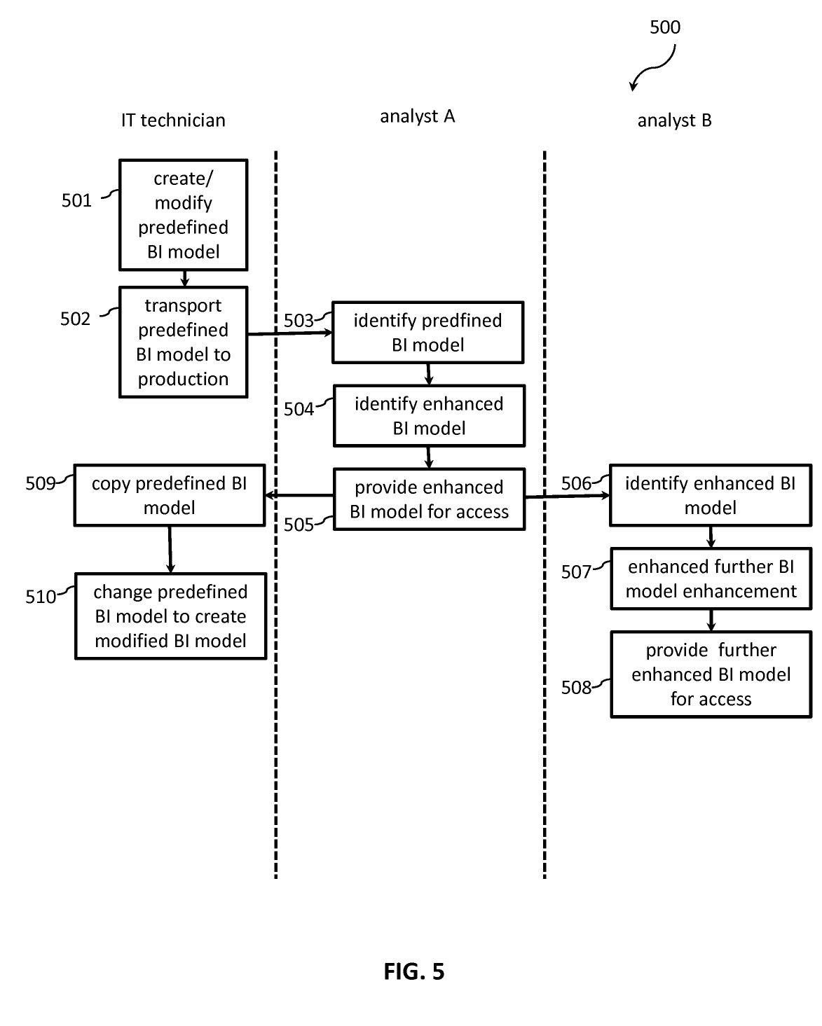

FIG. 5 illustrates examples of the operations described in connection of FIG. 1, FIG. 2 and FIG. 3A to FIG. 3C above. At operation 501, an IT technician creates or modifies a predefined business intelligence model and transports at operation 502 the created or modified business intelligence model to a productive database system. Analyst A identifies at operation 503 the predefined business intelligence model and at operation 504 analyst A identifies an enhanced business intelligence model based on the predefined businesses intelligence model. At operation 505, analyst A provides the identified enhanced business intelligence model for access in the database system. Optionally, at operation 506 a second analyst B identifies the enhanced business intelligence model of analyst A and identifies at operation 507 a further enhanced business intelligence model. This further enhanced business intelligence model is again provided for access in the database by analyst B at operation 508. Further optionally, IT technician T receives a pull request from analyst A to notify that an enhanced business intelligence model has been defined (not shown in FIG. 5). At operation 509, the IT technician T copies the predefined business intelligence model and at operation 510 the IT technician T changes the predefined business intelligence model to integrate one or more enhancements of the enhanced business intelligence model into the underlying model. The operations shown in FIG. 5 do not necessarily occur in the depicted order. In addition, one or several operations can occur between two operations depicted in FIG. 5.

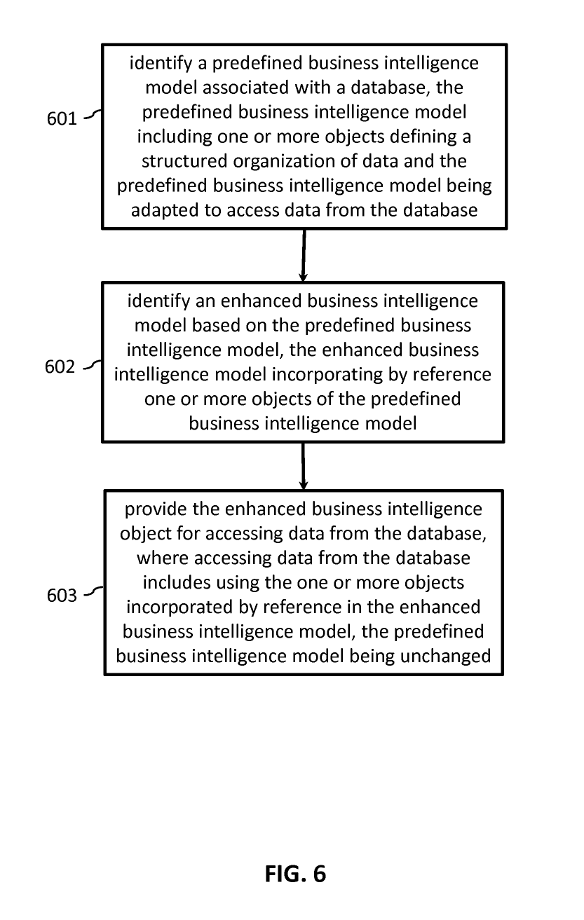

FIG. 6 illustrates an example method of enhancing business intelligence models. At operation 601, a user identifies a predefined business intelligence model associated with a database the predefined business intelligence model including one or more entities defining a structured organization of data and the predefined business intelligence model being adapted to access data from the database. At operation 602, the user identifies an enhanced business intelligence model based on the predefined business intelligence model the enhanced business intelligence model incorporating by reference one or more entities of the predefined business intelligence model. At step 603, the user provides the enhanced business intelligence model for accessing data from the database, where accessing data from the database includes using the one or more entities incorporated by reference in the enhanced business intelligence model and where the predefined business intelligence model is unchanged.

In connection with FIG. 4, several example hardware and software embodiments of the systems and methods described herein have been mentioned. Additionally or alternatively, the systems and methods described herein can be embodied as described subsequently.

At a high level, the application and the database server are associated with a computer or processor. A computer or processor comprises an electronic computing unit (e.g., a processor) operable to receive, transmit, process, store, or manage data and information associated with an operating environment of the database system. As used in the present disclosure, the term “computer” or “processor” is intended to encompass any suitable processing device. The term “processor” is to be understood as being a single processor that is configured to perform operations as defined by one or more aspects described in this disclosure, or the “processor” comprises two or more processors, that are configured to perform the same operations, e.g. in a manner that the operations are distributed among the two or more processors. The processor may comprise multiple organic field-effect transistors or thin film transistors or a combination thereof. This may allow processing the operations in parallel by the two or more processors. The two or more processors may be arranged within a supercomputer, the supercomputer may comprise multiple cores allowing for parallel processing of the operations. For instance, computer or processor may be a desktop or a laptop computer, a cellular phone, a smartphone, a personal digital assistant, a tablet computer, an e-book reader or a mobile player of media. Furthermore, the operating environment of the database system can be implemented using any number of servers, as well as computers other than servers, including a server pool. Indeed, the computer or processor and the server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the computer, processor and server may be adapted to execute any operating system, including Linux, UNIX, Windows, Mac OS, iOS, Android or any other suitable operating system.

The term “computing device,” “server,” or “processor” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array), a CUDA (Compute Unified Device Architecture) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and operating environment can realize various different computing model infrastructures. In enterprise systems, there are OLTP (OnLine Transaction processing) systems used to carry out business processes of a company where employees and other stakeholders, such as suppliers or customers, follow a business process which may result in business documents created in a database of the OLTP system. The database system can include in-memory databases in addition to the persistent databases described in connection with FIGS. 1 and 2 and thereby exploit recent innovations in hardware to run a database in main memory. In an implementation of the present disclosure described herein, the servers may be types of a Java development platform, such as e.g., Enterprise JavaBeans® (EJB), J2EE Connector Architecture (JCA), Java Messaging Service (JMS), Java Naming and Directory Interface (JNDI), and Java Database Connectivity (JDBC), a ByDesign platform, SuccessFactors Platform, ERP Suite technology or in-memory database such as High Performance Analytic Appliance (HANA) platform. In an aspect, the servers may be based on two different of the above mentioned platforms.

Regardless of the particular implementation, “software” or “operations” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Python and R, Perl, any suitable version of 4GL, as well as others.

The figures and accompanying description illustrate example processes and computer-implementable techniques. However, the database system operating environment (or its software or hardware components) contemplates using, implementing, or executing any suitable technique for performing these and other processes. It will be understood that these processes are for illustration purposes only and that the described or similar techniques may be performed at any appropriate time, including concurrently, individually, or in combination. In addition, many of the operations in these processes may take place simultaneously, concurrently, and/or in different orders or combinations than shown. Moreover, operating environment may use processes with additional operations, fewer operations, and/or different operations, so long as the methods remain appropriate.

Aspects of the subject-matter and the operations described in this specification can be implemented in digital electronic circuitry, semiconductor circuits, analog circuits, or in computer software, firmware, or hardware, including the structures disclosed in this specification and their structural equivalents, or in combinations of one or more of them. Embodiments of the subject-matter described in this specification can be implemented as one or more computer programs, i.e., one or more modules of computer program instructions, encoded on computer storage medium for execution by, or to control the operation of a data processing apparatus. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

A computer program (also known as a program, software, software application, script, or code) or “user interface” can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) “icons,” some or all associated with a web browser, such as interactive fields, pull-down lists, and buttons operable by the user of the computing device hosting the UI. These and other UI icons may be related to or represent the functions of the web browser. The term “browser user interface” refers to a graphical user interface embedded in a web browser environment on the remote computing device. The browser user interface may be configured to initiate a request for a uniform resource locator (URL) and may be configured to display a retrieved web page such as an HTML coded web page. The browser user interface may comprise displayed or hidden icons which, upon activation, initiate an associated electronic process inside or outside the remote computing device. For example, the browser user interface may be Internet Explorer, Chrome or Firefox. “Creating an icon” is to be understood as generating a new icon on the user interface. “Modifying an icon” is to be understood as changing a property of an existing icon on the user interface. “Deleting an icon” is to be understood as vanishing an existing icon on the user interface, e.g., for replacement by a newly created icon. “Updating the user interface” thereby is to be understood as creating, modifying, or deleting an icon on the user interface.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer or computer or processor may be a processor for performing actions in accordance with instructions and one or more memory devices for storing instructions and data. Generally, a computer or computer or processor will also include, or be operatively coupled to receive data from or transfer data to, or both, one or more mass storage devices for storing data, e.g., magnetic, magneto optical disks, or optical disks. However, a computer or computing device need not have such devices. Moreover, a computer or computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the user interface described in this specification can be implemented on a computer having a non-flexible or flexible screen, e.g., a CRT (cathode ray tube), LCD (liquid crystal display) or OLED (organic light emitting diode) monitor, for displaying information to the user and a keyboard and a pointer, e.g., a finger, a stylus, a mouse or a trackball, by which the user can provide input to the computer. Other kinds of devices can be used to provide for interaction with a user as well; for example, feedback provided to the user can be any form of sensory feedback, e.g., touch feedback, visual feedback, auditory feedback, or tactile feedback; and input from the user can be received in any form, including acoustic, speech, touch or tactile input. In addition, a computer or computer or processor can interact with a user by sending documents to and receiving documents from a device that is used by the user; for example, by sending web pages to a web browser on a user's user device in response to requests received from the web browser.

Implementations of the subject-matter described in this specification can be implemented in a computing system that includes a back end component, e.g., as a server, or that includes a middleware component, e.g., an application server, or that includes a front end component, e.g., a user computer having a graphical user interface or a Web browser through which a user can interact with an implementation of the subject-matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some implementations, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any implementation or on the scope of what may be claimed, but rather as descriptions of features that may be specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the operations recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
identifying a predefined business intelligence model associated with a database, wherein the predefined business intelligence model includes one or more entities defining a structured organization of data and wherein the predefined business intelligence model is adapted to access data from the database;
identifying an enhanced business intelligence model based on the predefined business intelligence model, wherein the enhanced business intelligence model incorporates by reference one or more entities of the predefined business intelligence model; and
providing the enhanced business intelligence model for accessing data from the database, wherein accessing data from the database includes using the one or more entities incorporated by reference in the enhanced business intelligence model, wherein the predefined business intelligence model is unchanged.

2. The computer implemented method of claim 1, wherein the enhanced business intelligence model is set up by an analyst user having only read access to the predefined business intelligence model.

3. The computer-implemented method of claim 2, further comprising:
identifying the enhanced business intelligence model; and
identifying a further enhanced business intelligence model based on the enhanced business intelligence model, wherein the further enhanced business intelligence model incorporates by reference one or more entities of the enhanced business intelligence model.

4. The computer-implemented method of claim 3, wherein the further enhanced business intelligence model is set up by a second analyst user having only read access to the predefined business intelligence model.

5. The computer implemented method of claim 1, wherein the predefined business intelligence model is set up by an IT technician having the right to create a business intelligence model.

6. The computer-implemented method of claim 1, further comprising:
declaring the enhanced business intelligence model to be a read-only model that cannot be modified by one or more other analysts having only read access to the predefined business intelligence model, or
declaring the enhanced business intelligence model to be a read/write model that can be modified by one or more other analysts having only read access to the predefined business intelligence model and write access to the enhanced business intelligence model.

7. The computer-implemented method of claim 1, wherein the database is an in-memory database and wherein the database is associated with a production database system, and wherein the enhanced business intelligence model is associated with an ad hoc database query definition.

8. The computer-implemented method of claim 1, wherein identifying an enhanced business intelligence model includes defining one or more new entities not present in the predefined business intelligence model.

9. The computer-implemented method of claim 1, wherein identifying an enhanced business intelligence model includes adding new database tables to the predefined business intelligence model.

10. The computer-implemented method of claim 1, wherein the one or more entities of the predefined business intelligence model have an identifier that cannot be changed by an analyst setting up the enhanced business intelligence model.

11. The computer-implemented method of claim 1, further comprising:
defining an annotation for one or more entities of the predefined business intelligence model or one or more of their attributes for organizing the one or more entities in the enhanced business intelligence model.

12. The computer implemented method of claim 1, further comprising:
notifying an IT technician having read and write access to the complete database that an enhanced business intelligence model has been set up;
adding the enhanced business intelligence model to the predefined business intelligence model to create a modified business intelligence model.

13. The computer implemented method of claim 12, further comprising:
notifying other users of the database using the predefined business intelligence model about the modified business intelligence model.

14. The computer implemented method of claim 1, wherein the enhanced business intelligence model incorporates one or more entities of the predefined business intelligence mode by referencing without rewriting the one or more entities.

15. The computer implemented method of claim 1, further comprising:
changing the predefined business intelligence model to include one or more enhancement of the enhanced business intelligence model to create a modified business intelligence model;
automatically mapping the references to the one or more entities of the predefined business intelligence model to one or more entities of the modified business intelligence model.

16. The computer implemented method of claim 15, wherein a user of the predefined business intelligence model is not notified about the creation of the modified business intelligence model.

17. The computer implemented method of claim 15, further comprising:
copying the predefined business intelligence model to create a backup version of the predefined business intelligence model; and
notifying a user about the creation of the modified business intelligence model.

18. The computer implemented method of claim 1, further comprising:
copying the predefined business intelligence model to create a copied predefined business intelligence model;
changing the copied predefined business intelligence model to include one or more enhancement of the enhanced business intelligence model to create a modified business intelligence model;
marking the predefined business intelligence model as deprecated; and
instructing a user to change the references from the deprecated predefined business intelligence model to the modified business intelligence model.

19. A computer readable medium storing instructions thereon which when executed by a processor cause the processor to:
identify a predefined business intelligence model associated with a database, wherein the predefined business intelligence model includes one or more entities defining a structured organization of data and wherein the predefined business intelligence model is adapted to access data from the database;
identify an enhanced business intelligence model based on the predefined business intelligence model, wherein the enhanced business intelligence model incorporates by reference one or more entities of the predefined business intelligence model; and
provide the enhanced business intelligence object for accessing data from the database, wherein accessing data from the database includes using the one or more entities incorporated by reference in the enhanced business intelligence model, wherein the predefined business intelligence model is unchanged.

20. A system comprising:
one or more processors; and
a computer-readable medium storing instructions executable by the one or more processors to perform operations comprising:
identify a predefined business intelligence model associated with a database, wherein the predefined business intelligence model includes one or more entities defining a structured organization of data and wherein the predefined business intelligence model is adapted to access data from the database;
identify an enhanced business intelligence model based on the predefined business intelligence model, wherein the enhanced business intelligence model incorporates by reference one or more entities of the predefined business intelligence model; and
provide the enhanced business intelligence model for accessing data from the database, wherein accessing data from the database includes using the one or more entities incorporated by reference in the enhanced business intelligence model, wherein the predefined business intelligence model is unchanged.
